(19) United States
(12) Patent Application Publication
(10) Pub. No.: US 2006/0214910 A1
(43) Pub. Date: Sep. 28, 2006

(54) Electronic apparatus including fingerprint sensor

(75) Inventors: Yusuke Mizuno, Kawasaki (JP); Sonomasa Kobayashi, Kawasaki (JP); Kaigo Tanaka, Kawasaki (JP); Yukihiro Ueki, Tokyo (JP); Minoru Suzuki, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/192,141

(22) Filed: Jul. 29, 2005

(30) Foreign Application Priority Data
Mar. 28, 2005 (JP) 2005-092343

(51) Int. Cl. G09G 5/00

(52) U.S. Cl. 345/156

(57) ABSTRACT

A rectangular screen is defined on the front surface of a second enclosure coupled to a first enclosure. The second enclosure rotates relative to the first enclosure around a first rotation axis established along a first side of the rectangular screen and around a second rotation axis defined within a plane perpendicular to the first rotation axis. A fingerprint sensor is located on the front surface of the second enclosure outside a second side of the rectangular screen intersecting with the first side. When the second enclosure takes an upright attitude relative to the first enclosure, or when the back surface of the second enclosure is received on the front surface of the first enclosure based on the rotation around the first and second axes, the authentication of fingerprints can reliably can be achieved in a facilitated manner irrespective of the relative position between the first and second enclosures.

### BACKGROUND OF THE INVENTION

1. Field of the Invention

The present invention relates to an electronic apparatus such as a notebook personal computer, for example. In particular, the invention relates to an electronic apparatus including a first enclosure and a second enclosure capable of rotating relative to the first enclosure around a first rotation axis and a second rotation axis defined within a plane set perpendicular to the first rotation axis.

2. Description of the Prior Art

A notebook personal computer includes a main body enclosure and a display enclosure. A keyboard is exposed on the front surface of the main body enclosure. A liquid crystal display (LCD) panel is exposed on the front surface of the display enclosure. The display enclosure is coupled to the main body enclosure through a swivel mechanism. The swivel mechanism realizes the rotation of the display enclosure relative to the main body enclosure around a horizontal axis. The display enclosure is in this manner folded over the front surface of the main body enclosure through the rotation around the horizontal axis.

The notebook personal computer sometimes includes a fingerprint sensor located on the front surface of the main body enclosure, as disclosed in Japanese Patent Application Publication No. 2002-82740, for example. When the user touches the fingerprint sensor with a finger, the fingerprint of the user can be sensed. The sensed fingerprint is authenticated based on comparison with the registered fingerprint.

The notebook personal computer recently sometimes allows the rotation of the horizontal axis around the vertical axis perpendicular to a horizontal plane including the horizontal axis. The display enclosure is thus allowed to rotate around the vertical axis on the main body enclosure. When the display enclosure is folded over the main body enclosure, either the front or back surface of the display enclosure can be received on the front surface of the main body enclosure.

When the back surface of the display enclosure is received on the front surface of the main body enclosure, for example, the screen of the LCD panel gets exposed outward. In this case, the user is allowed to utilize a touch screen panel on the front surface of the LCD panel so as to input data and instructions into the notebook personal computer. However, since the fingerprint sensor is covered with the display enclosure under this circumstance, the user is forced to change the attitude of the display enclosure every time the user intends to utilize the fingerprint sensor.

### SUMMARY OF THE INVENTION

It is accordingly an object of the present invention to provide an electronic apparatus realizing the authentication of a fingerprint in a facilitated manner irrespective of a relative position between first and second enclosures.

According to the present invention, there is provided an electronic apparatus comprising: a first enclosure; a second enclosure defining a rectangular screen on the front surface, said second enclosure designed to rotate relative to the first enclosure around a first rotation axis established along a first side of the rectangular screen and around a second rotation axis defined within a plane perpendicular to the first rotation axis; and a fingerprint sensor located on the front surface of the second enclosure outside a second side of the rectangular screen intersecting with the first side.

The electronic apparatus enables location of the fingerprint sensor on the front surface of the second enclosure. When the second enclosure takes an upright attitude relative to the first enclosure, or when the back surface of the second enclosure is received on the front surface of the first enclosure based on the rotation around the first and second axes, the authentication of fingerprints can reliably be realized. Moreover, the authentication of fingerprints can be achieved in a facilitated manner irrespective of the relative position between the first and second enclosures.

In addition, when the front surface of the second enclosure is received on the front surface of the first enclosure, the fingerprint sensor is covered with the first enclosure. Exposure of the fingerprint sensor is reliably avoided. The fingerprint sensor can reliably be prevented from suffering from damages.

The fingerprint sensor may be designed to scan the fingerprint of a finger moving outward from the screen. The finger of the user is always moved to get distanced from the outline of the second enclosure after the movement on the fingerprint sensor for the authentication of the fingerprint, for example. The finger of the user is reliably prevented from touching the screen during the authentication of the fingerprint. The screen can reliably be prevented from suffering from generation of scratches or the like.

The screen may be defined on a touch screen panel unit incorporated within the second enclosure. In this case, the finger of the user is reliably prevented from touching the touch screen panel during the authentication of the fingerprint. Erroneous operations of the touch screen panel can thus reliably be avoided. If the finger of the user is invited to move in the inward direction toward the screen for the authentication of a fingerprint, the finger of the user often touches the screen. The touch of the finger sometimes induces erroneous operations of the touch screen panel.

The electronic apparatus may further comprise a controlling circuit designed to switch over first and second image positions when the back surface of the second enclosure is received on the front surface of the first enclosure, said first image position utilized to align the lower end of an image with the first side in the screen, said second image position utilized to align the lower end of the image with the second side in the screen.

When the lower end of the image is aligned with the first side in the screen at the first image position, the user is allowed to use the electronic apparatus with the first side serving as the lower end. When the lower end of the image is aligned with the second side in the screen at the second image position, the user is allowed to use the electronic apparatus with the second side serving as the lower end. The user is in this manner allowed to use the electronic apparatus lengthwise and widthwise depending on purposes. Since the fingerprint sensor is located on the front surface of the second enclosure in the aforementioned manner, the authentication of the fingerprint can be achieved in a facilitated manner any time when the electronic apparatus is used either lengthwise or widthwise.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating the structure of a notebook personal computer as a specific example of an electronic apparatus according to the present invention;

FIG. 2 is a perspective view of the notebook personal computer when the front surface of a display enclosure is received on the front surface of a main body enclosure;

FIG. 3 is a perspective view of the notebook personal computer when the display enclosure has rotated around the vertical axis;

FIG. 4 is a perspective view of the notebook personal computer when the back surface of the display enclosure is received on the front surface of the main body enclosure;

FIG. 5 is a plan view of the notebook personal computer with an image of a first image position when the back surface of the display enclosure is received on the front surface of the main body enclosure;

FIG. 6 is a plan view of the notebook personal computer with an image of a second image position when the back surface of the display enclosure is received on the front surface of the main body enclosure;

FIG. 7 is a block diagram schematically illustrating the structure of a main control system of the notebook personal computer; and

FIG. 8 is en enlarged partial plan view of the notebook personal computer for schematically illustrating the movement of a finger over a fingerprint sensor.

### DESCRIPTION OF THE PREFERRED EMBODIMENT

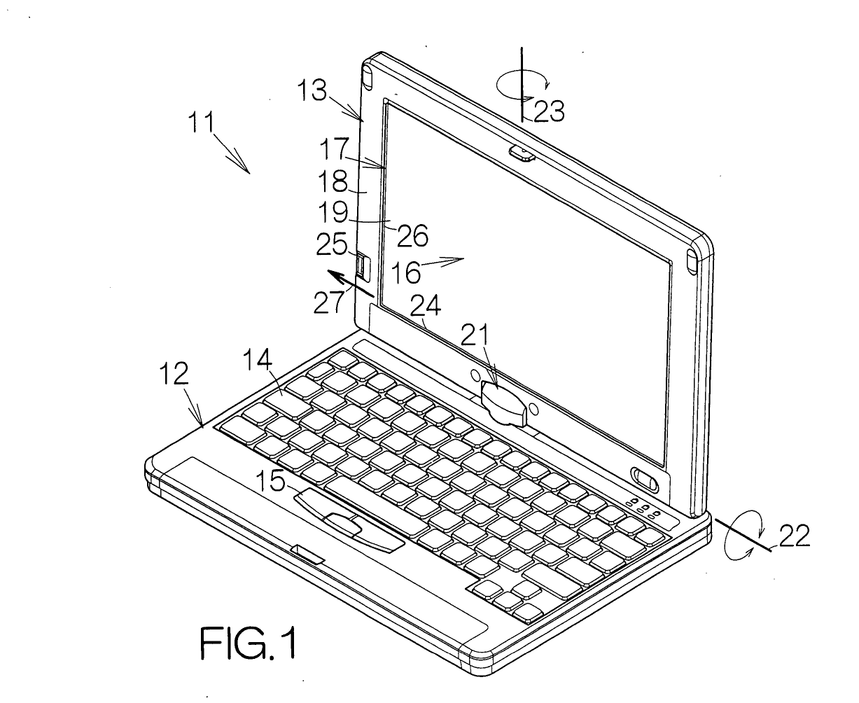

FIG. 1 schematically illustrates a notebook personal computer 11 as a specific example of an electronic apparatus according to an embodiment of the present invention. The notebook personal computer 11 includes a first enclosure or main body enclosure 12 and a second enclosure or display enclosure 13 coupled to the main body enclosure 12. The main body enclosure 12 and the display enclosure 13 may be made of a reinforced resin material such as polycarbonate, for example.

A motherboard is enclosed within the main body enclosure 12. Electronic circuit elements such as a central processing unit, CPU, a memory, and the like, are mounted on the motherboard. The central processing unit is designed to execute various processing or calculation based on software programs and/or data temporarily stored in the memory, for example. The software programs and data may be stored in a mass storage such as a hard disk drive, HDD, enclosed within the main body enclosure 12.

Input devices such as a keyboard 14, a pointing device 15, and the like, are located on the front surface of the main body enclosure 12. The keyboard 14 includes keypads arranged on an imaginary plane. The user utilizes the input devices 14, 15 so as to input various instructions and data to the central processing unit.

A flat display panel such as a liquid crystal display (LCD) panel 16, for example, is incorporated in the display enclosure 13. The LCD panel 16 defines a screen 17 inside an endless frame 18 of the display enclosure 13. The screen 17 may be formed in a rectangular shape. Various texts and/or graphics can be displayed on the screen 17 in response to the operation of the central processing unit.

An input device such as a touch screen panel 19 is placed on the front surface of the LCD panel 16. Any type of touch screen panel, such as optical type, electrostatic type, ultrasonic type, resistive type, or the like, may be employed as the touch screen panel 19. The touch screen panel 19 and the LCD panel 16 in combination establish a so-called touch screen panel unit. In the case where the resistive type may be employed as the touch screen panel 19, the user is allowed to manipulate the touch screen panel 19 with a finger of the user so as to input various instructions and data to the central processing unit.

A bi-axial swivel mechanism 21 is employed to couple the display enclosure 13 with the main body enclosure 12. The swivel mechanism 21 realizes the rotation of the display enclosure 13, relative to the main body enclosure 12, not only around a first rotation axis or horizontal axis 22 but also around a second rotation axis or vertical axis 23.

The horizontal axis 22 is defined along a first side 24 of the rectangular screen 17. Here, the first side 24 corresponds to the lower end of the screen 17 set widthwise. The horizontal axis 22 may extend in parallel with the front surface of the main body enclosure 12. The vertical axis 23 is established within a plane set perpendicular to the horizontal axis 22. The vertical axis 23 stands upright from the front surface of the main body enclosure 12.

A fingerprint sensor 25 is located on the display enclosure 13 at the front surface of the frame 18. The fingerprint sensor 25 is positioned at a position outside a second side 26 of the rectangular screen 17. The second side 26 intersects with the first side 24. The second side 26 may be set perpendicular to the first side 24. Here, the second side 26 corresponds to a left-hand side of the screen 17 set widthwise.

The fingerprint sensor 25 is located inside the outline of the front surface of the frame 18 namely the display enclosure 13. The fingerprint sensor 25 is designed to sense a fingerprint based on a finger moving in an outward direction 27 from the screen 17. The finger may be moved in parallel with the front surface of the frame 18, for example. The sensed fingerprint may temporarily be stored in the memory as a fingerprint data for example. The outward direction 27 may be established in parallel with the horizontal axis 22.

The fingerprint sensor 25 is usually utilized to realize authentication to log-on into an operating system, OS, or a network, boot-up of a software program, and the like. The user is invited to register a fingerprint data based on a finger of a hand in advance. The central processing unit implements a software program for authentication of fingerprints stored in the hard disk drive so as to authenticate the sensed fingerprint based on comparison with the stored fingerprint data, for example. Authentication of fingerprints is in this manner realized.

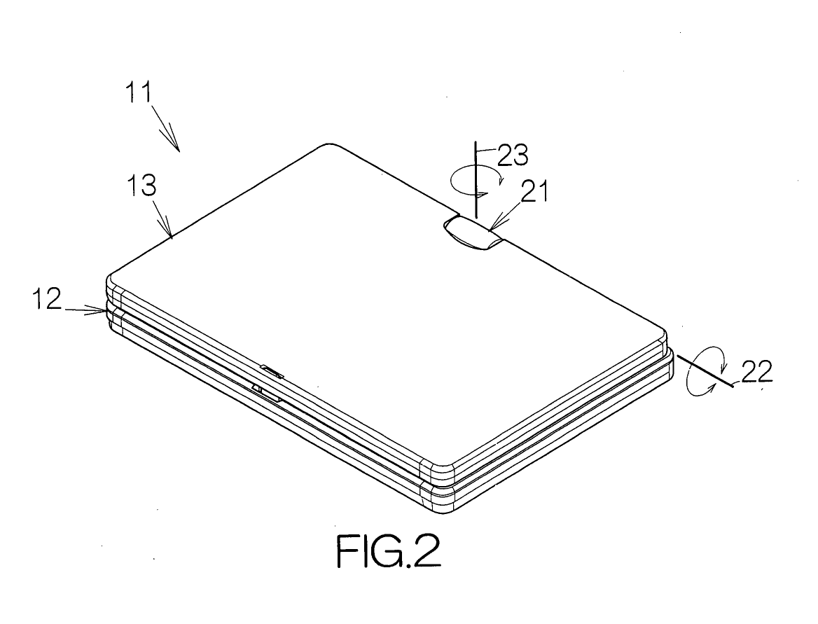

Now, assume that the front surface of the display enclosure 13 is received on the front surface of the main body enclosure 12 through the rotation of the display enclosure 13 around the horizontal axis 22. As shown in FIG. 1, the display enclosure 13 takes a first upright attitude through the rotation around the vertical axis 23. As shown in FIG. 2, the display enclosure 13 taking the first upright attitude is allowed to rotate around the horizontal axis 22, so that the display enclosure 13 is folded over the main body enclosure 12. The display enclosure 13 thus takes a first folded attitude. The front surface of the display enclosure 13 or the screen 17 of the LCD panel 16 is opposed to the front surface of the main body enclosure 12. The outline of the display enclosure 13 is homologized with the outline of the main body enclosure 12. The notebook personal computer 11 can be folded in this manner.

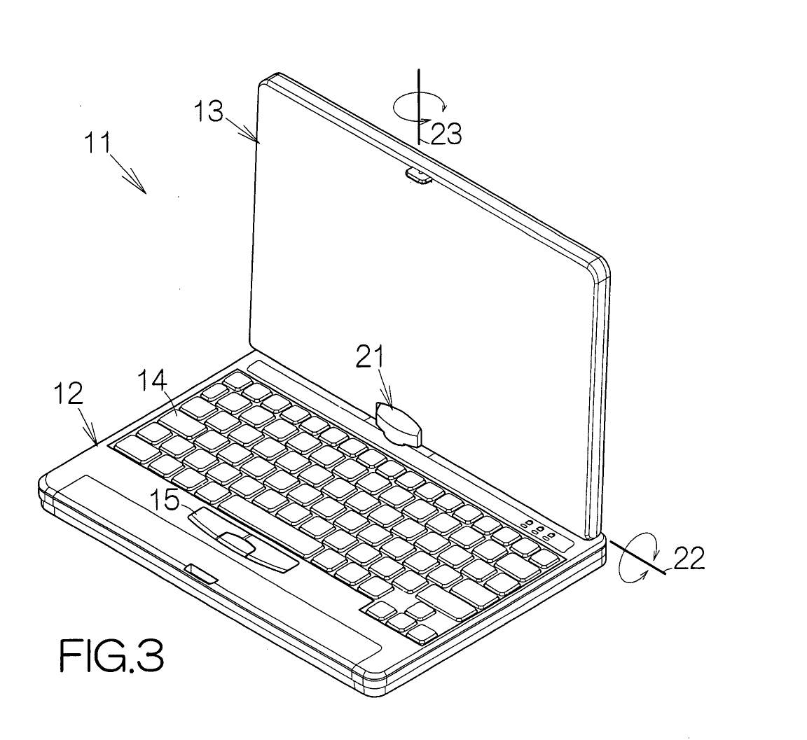

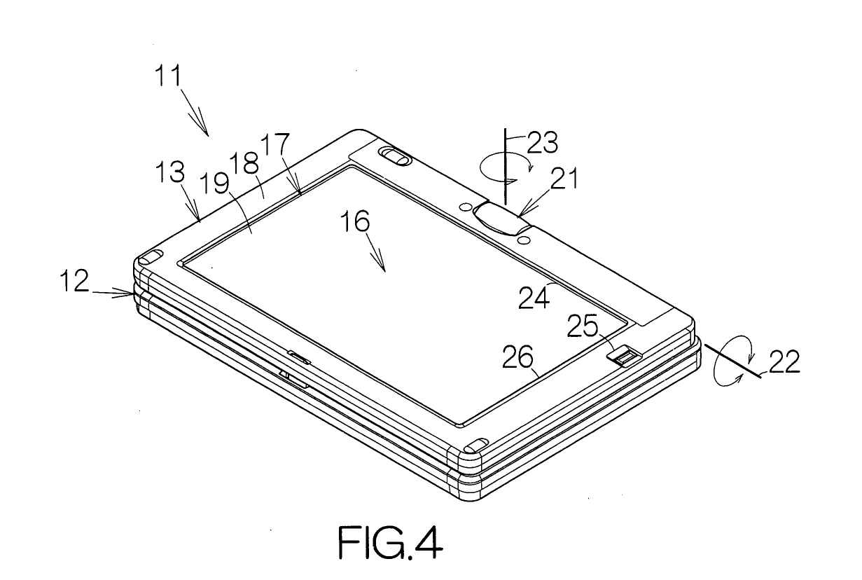

As shown in FIG. 3, the display enclosure 13 is allowed to rotate around the vertical axis 23 over 180 degrees relative to the main body enclosure 12, for example. The display enclosure 13 thus takes a second upright attitude through the rotation around the vertical axis 23. As shown in FIG. 4, the display enclosure 13 taking the second upright attitude is allowed to rotate around the horizontal axis 23, so that the display enclosure 13 is folded over the main body enclosure 12. The display enclosure 13 thus takes a second folded attitude. In this case, the back surface of the display enclosure 13 is opposed to the front surface of the main body enclosure 12. The outline of the display enclosure 13 is homologized with the outline of the main body enclosure 12. The notebook personal computer 11 can in this manner be folded with the display enclosure 13 reversed.

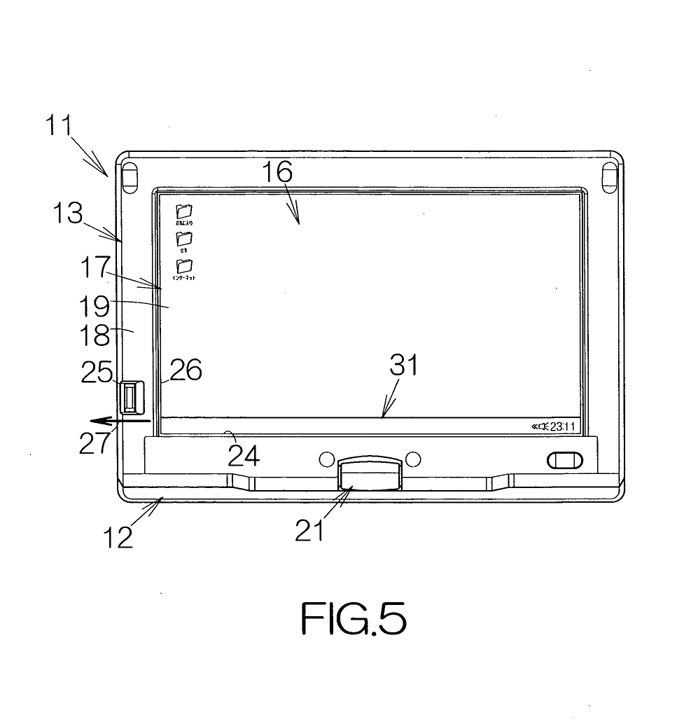

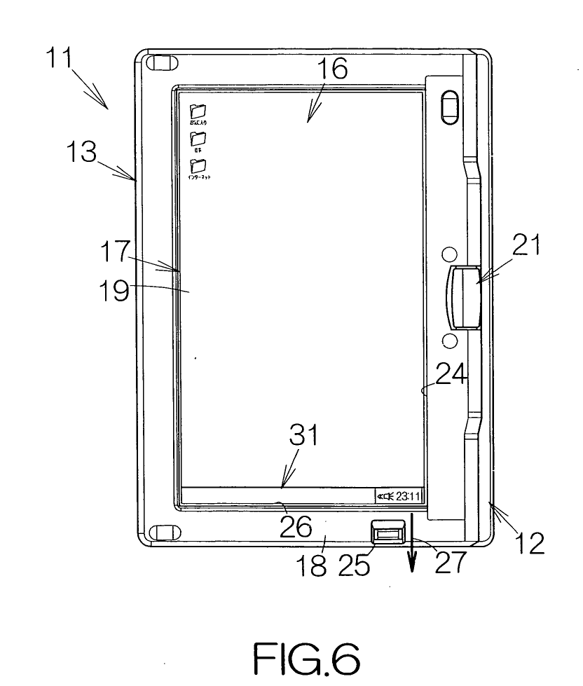

As shown in FIG. 5, when the display enclosure 13 takes the second folded attitude, an image on the screen 17 can be switched over between a first image position and a second image position. When an image takes the first image position in the screen 17 of the LCD panel 16, as shown in FIG. 5, the lower end 31 of the image, such as a task bar of an operating system, OS, is aligned with the first side 24 in the screen 17. When an image takes the second image position in the screen 17, as shown in FIG. 6, the lower end 31 of the image is aligned with the second side 26 in the screen 17. The user is in this manner allowed to use the notebook personal computer 11 lengthwise and widthwise depending on purposes.

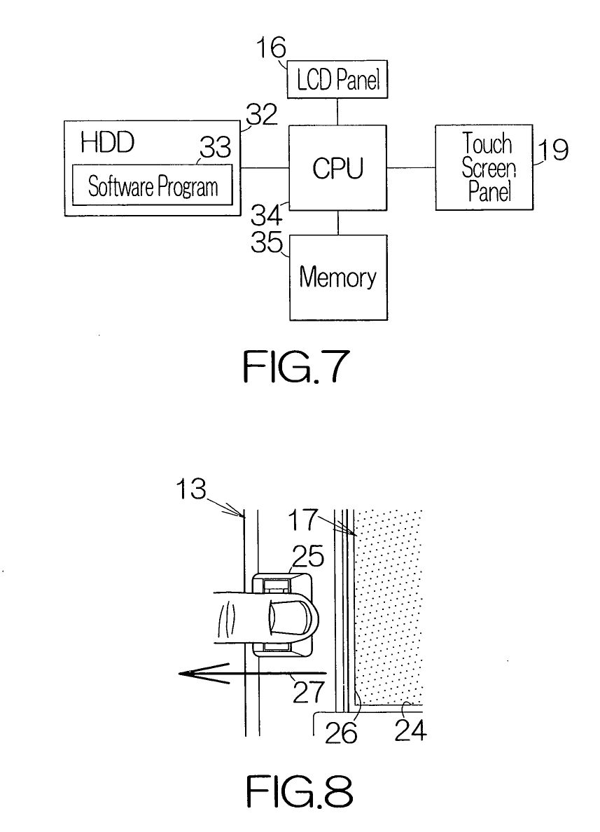

As shown in FIG. 7, the switchover between the first and second image positions may be achieved through implementation of a software program 33 stored in the hard disk drive 32, for example. The central processing unit 34 executes the processing based on the software program temporarily held in the memory 35. The central processing unit 34 supplies image data to the LCD panel 16 based on the processing. The image in this manner rotates on the screen 17 of the LCD panel 16.

The switchover of the first and second image positions may be effected in response to the manipulation of the touch screen panel 19. In this case, the central processing unit 34 may receive instructions for the switchover from the touch screen panel 19. Otherwise, a sensor, not shown, may be utilized in the notebook personal computer 11 so as to detect the attitude of the notebook personal computer 11. The central processing unit 34 may automatically switch over the first and second image positions based on the output of the sensor.

The notebook personal computer 11 allows the alignment of the lower end of an image with the first side 24 in the screen 17, as shown in FIG. 1, when the display enclosure 13 takes the first upright attitude through the rotation around the vertical axis 23. The user is simply allowed to move a finger in the outward direction 27 from the screen 17 as shown in FIG. 8, for example, for the authentication of the fingerprint.

When an image takes the first image position in the screen 17 during the second folded attitude of the display enclosure 13, as shown in FIG. 5, the lower end 31 of the image is aligned with the first side 24 in the screen 17. The notebook personal computer 11 is in this manner set widthwise. The user is simply allowed to move a finger of the left hand in the outward direction 27 from the screen 17 in the aforementioned manner for the authentication of the fingerprint.

When an image takes the second image position in the screen 17 during the second folded attitude of the display enclosure 13, as shown in FIG. 6, the lower end 31 of the image is aligned with the second side 26 of the screen 17. The notebook personal computer 11 is in this manner set lengthwise. The user is simply allowed to move a finger of the left hand in the outward direction 27 from the screen 17 in the aforementioned manner for the authentication of the fingerprint.

The fingerprint sensor 25 is disposed on the front surface of the display enclosure 13 in the notebook personal computer 11. When the display enclosure 13 takes the first upright attitude or second folded attitude, the authentication of fingerprints can reliably be realized. Moreover, the authentication of fingerprints can be achieved in a facilitated manner irrespective of the relative position between the main body enclosure 12 and the display enclosure 13.

Moreover, the fingerprint sensor 25 is located on the front surface of the frame 18. The finger of the user is always moved to get distanced from the outline of the display enclosure 13 after the movement on the fingerprint sensor 25 for the authentication of the fingerprint. The finger of the user is reliably prevented from touching the screen 17 during the authentication of the fingerprint. Erroneous operations of the touch screen panel 19 are reliably avoided.

If a finger of the user is invited to move in the inward direction toward the screen 17 for the authentication of a fingerprint, the finger of the user often touches the screen 17. Since the touch screen panel 19 is disposed over the front surface of the screen 17, the touch of the finger sometimes induces erroneous operations of the touch screen panel 19.

In addition, the fingerprint sensor 25 is located inside the outline of the front surface of the frame 18. Accordingly, the fingerprint sensor 25 can be covered with the main body enclosure 12 when the display enclosure 13 is folded over the front surface of the main body enclosure 12. Exposure of the fingerprint sensor 25 is thus avoided. The fingerprint sensor 25 is reliably prevented from suffering from damages.

The electronic apparatus of the invention may include, in addition to the aforementioned notebook personal computer 11, a cellular phone terminal apparatus, a personal digital assistance, PDA, a tablet personal computer, and the like.

What is claimed is:

1. An electronic apparatus comprising:
a first enclosure;
a second enclosure defining a rectangular screen on a front surface, said second enclosure designed to rotate relative to the first enclosure around a first rotation axis established along a first side of the rectangular screen and around a second rotation axis defined within a plane perpendicular to the first rotation axis; and
a fingerprint sensor located on the front surface of the second enclosure outside a second side of the rectangular screen intersecting with the first side.

2. The electronic apparatus according to claim 1, wherein said fingerprint sensor is designed to scan a fingerprint of a finger moving outward from the screen.

3. The electronic apparatus according to claim 1, further comprising a controlling circuit designed to switch over first and second image positions when a back surface of the second enclosure is received on a front surface of the first enclosure, said first image position utilized to align the lower end of an image with the first side in the screen, said second image position utilized to align the lower end of the image with the second side in the screen.

4. The electronic apparatus according to claim 1, wherein said screen is defined on a touch screen panel unit incorporated within the second enclosure.
